(19) United States
(12) Patent Application Publication
(10) Pub. No.: US 2011/0078198 A1
(43) Pub. Date: Mar. 31, 2011

(54) AUTOMATIC SERIAL NUMBER AND REQUEST ID ALLOCATION IN A REPLICATED (CLONED) CERTIFICATE AUTHORITY AND DATA RECOVERY MANAGEMENT TOPOLOGY

(76) Inventors: Ade Lee, Cary, NC (US); Christina Fu, Saratoga, CA (US); Andrew Wnuk, San Jose, CA (US)

(21) Appl. No.: 12/571,393

(22) Filed: Sep. 30, 2009

(51) Int. Cl. G06F 17/30; G06F 15/173

(52) U.S. Cl. 707/783; 709/224; 709/226; 707/E17.005; 707/E17.014

(57) ABSTRACT

A Serial Number Management System (SNMS) automatically manages the allocation of unique serial numbers to certificate authority servers in a replicated server environment. The SNMS automatically detects that a Certificate Authority (CA) server has a need for a new set of unused serial numbers. The SNMS obtains a global serial number that is available to be used by any of the CA servers in a replication domain. The SNMS determines the new set of the unused serial numbers using the global serial number and updates the global serial number.

### RELATED APPLICATION

The present application is related to co-filed U.S. patent application Ser. No. ______ entitled “Automatic Server Administration of Serial Numbers in a Replicated Certificate Authority Topology” (attorney docket number 5220.P682), which is assigned to the assignee of the present application.

### TECHNICAL FIELD

Embodiments of the present invention relate to certificate authority servers in a replicated server environment. Specifically, the embodiments of the present invention relate to a method and system for automatic serial number and request ID allocation in a replicated (cloned) certificate authority and data recovery management topology.

### BACKGROUND

A certificate system provides a security framework to ensure that network resources are accessed by authorized users. The certificate system is capable of generating digital certificates (certificates) for different users to verify the identity of a presenter. The certificate system can include interoperating subsystems to perform various Public Key Infrastructure (PKI) operations, such as issuing, renewing, suspending, revoking, archiving and recovering keys, publishing Certificate Revocation Lists (CRLs), verifying certificate status, and managing the certificates that are needed to handle strong authentication and secure communications. The certificate system can include a Certificate Authority (CA) subsystem to issue and revoke certificates, a Data Recovery Manager (DRM) subsystem to recover lost keys, an Online Certificate Status Responder (OCSP) subsystem to verify whether a certificate is valid, a Registration Authority (RA) subsystem to accept certificate requests and verify whether a request should be approved, a Token Key Service (TKS) subsystem to format tokens and process certificates on a token, and a Token Processing System (TPS) to manage certificates on tokens.

A CA subsystem issues certificates which each having a unique serial number. An initial CA subsystem can be cloned to support large deployments to create a high availability certificate system that includes multiple CA subsystems. Each CA subsystem can receive certificate requests and issue certificates. To ensure that each certificate that is issued has a unique serial number, each CA subsystem must have a set of serial numbers that is unique from any other CA subsystem. The current state of the art, however, does not provide a way to efficiently manage the allocation of serial numbers to CA subsystems in a high availability certificate system that includes hundreds of CA subsystem clones.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an exemplary network architecture in which embodiments of the present invention may operate.

FIG. 2 illustrates a diagrammatic representation of a serial number management system, in accordance with one embodiment of the present invention.

FIG. 3 is a flowchart which illustrates an embodiment of a method for automatically requesting and obtaining additional serial numbers.

FIG. 4 is a flowchart which illustrates an embodiment of a method for automatically requesting and obtaining additional serial numbers.

FIG. 5 is a diagram of one embodiment of the serial number management system.

### DETAILED DESCRIPTION

Embodiments of the invention are directed to a method and system for automatically managing the allocation of unique serial numbers to certificate authority servers in a replicated server environment. A Serial Number Management System (SNMS) automatically detects that a Certificate Authority (CA) server has a need for a new set of unused serial numbers. The SNMS obtains a global serial number that is available to be used by any of the CA servers in a replication domain. The SNMS determines the new set of the unused serial numbers using the global serial number and updates the global serial number. The SNMS replicates the updated global serial number to the other CA servers in the replication domain. The CA server assigns a serial number to a certificate using a serial number from the new set of the unused serial numbers.

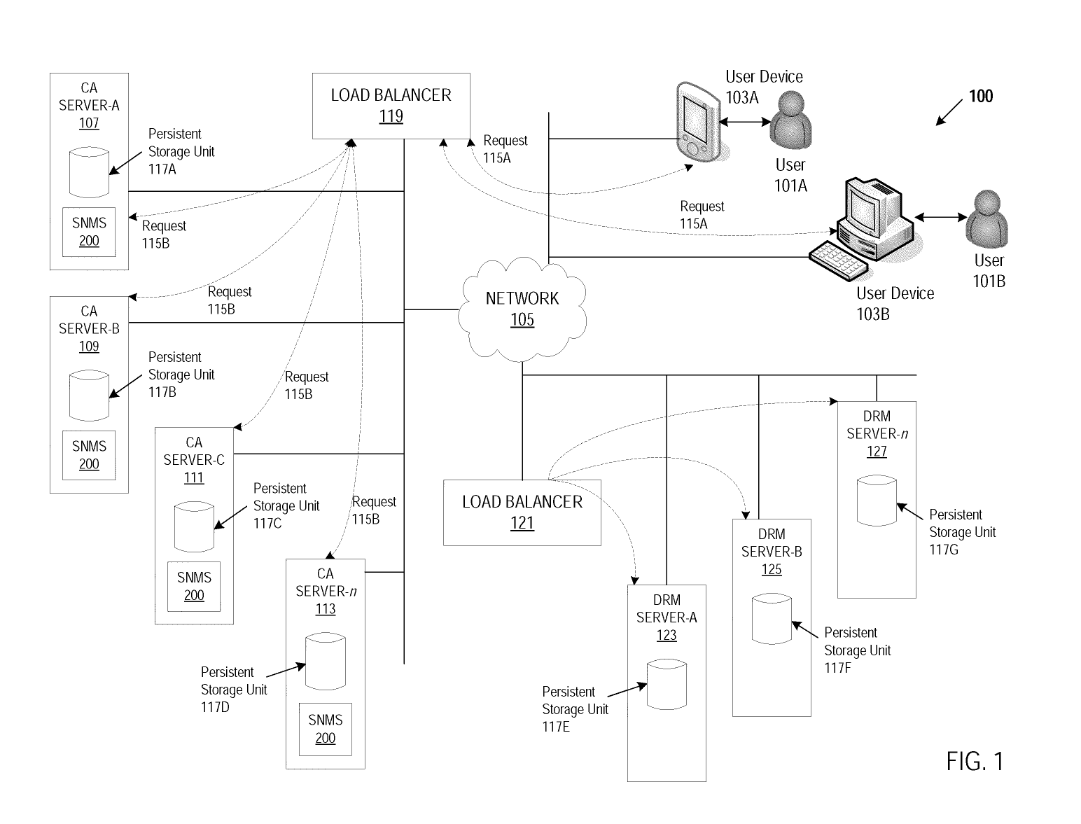

FIG. 1 illustrates an exemplary network architecture on which embodiments of the present invention can be implemented. User devices 103A, B for users 101A, B are coupled to a network 105. User devices 103A, B can be a smart hand-held device or any type of computing device including desktop computers, laptop computers, mobile communications devices, cell phones, smart phones, hand-held computers or similar computing device capable of transmitting certificate requests and receiving certificates. The network 105 can be a wide area network (WAN), such as the Internet, a local area network (LAN), such as an intranet within a company, a wireless network, a mobile communications network, or a similar communication system. The network 105 can include any number of networking and computing devices such as wired and wireless devices.

A high availability certificate system 100 includes an initial Certificate Authority (CA) server 107 and one or more clones 109,111,113 of the initial CA server 107. An initial CA server 107 is typically the first CA server that is configured in a high availability certificate system 100. A CA server can be any type of computing device including server computers, desktop computers, laptop computers, hand-held computers, or similar computing device. An initial CA server 107 is duplicated, or cloned, so that one or more clones 109-113 are set up in an identical manner. The high availability certificate system 100 can include hundreds of clones 109-113 of the initial CA server 107.

A user 101A, B sends a certificate request 115A over network 105. A CA server 107-113 receives certificate requests from users 101A, B, and generates and manages the certificates. The high availability certificate system 100 provides fail over support by ensuring that certificate requests are processed even if one of the CA servers 107-113 is unavailable. In one embodiment a load balancer 119 receives certificate requests 115A from users 101A, B and directs the requests 115B appropriately between the multiple CA servers 107-113. The load balancer can be part of a server machine, a gateway, etc. In the event that a CA server fails, the load balancer 119 can transparently redirect all requests to a CA server that is still operational.

A CA server 107-113 includes a persistent storage unit 117 (117A,B,C,D) for storing information such as certificates, requests, users, roles, access control lists (ACLs), and other information. The persistent storage unit 117 also stores serial number data. A persistent storage unit 117 can be a local storage unit or a remote storage unit. Persistent storage units can be a magnetic storage unit, optical storage unit, solid state storage unit or similar storage unit. Persistent storage units can be a monolithic device or a distributed set of devices. A ‘set,’ as used herein, refers to any positive whole number of items.

The high availability certificate system 100 can store serial number data using a directory that stores all of the information in a single, network-accessible repository. The serial number data includes the set (range) of serial numbers that is assigned to a CA server and the number of unused serial numbers for a CA server. A CA server has a next serial number and an ending serial number to represent its set of assigned serial numbers. The serial number data also includes a global serial number which is a serial number that is available to be used by any of the CA servers in a replication domain. A replication domain is a group of CA servers that replicate data to each other. The global serial number is a serial number that is greater than the ending serial number of any CA server in the replication domain. The directory can be a directory that uses a Lightweight Directory Access Protocol (LDAP) protocol. However, it is expressly contemplated that any appropriate directory and directory service can be enhanced for use in accordance with the allocation architecture described herein. The high availability certificate system 100 can communicate with an internal LDAP-based database securely through SSL client authentications.

Each CA server 107-113 includes a Serial Number Management System (SNMS) 200. An initial CA server and the multiple clones of the initial CA server use the same CA signing certificate, but each CA server issues certificates from a different set of serial numbers. A SNMS 200 automatically manages the allocation of unique serial numbers to the multiple CA servers 107-113 in the high availability certificate system 100. A SNMS 200 can automatically detect that a CA server has a need for a new set of unused serial numbers. A set of unused serial number are serial numbers that have not been assigned by a CA server to a certificate. The SNMS obtains a global serial number that is available to be used by any of the CA servers in a replication domain. The SNMS determines the new set of the unused serial numbers using the global serial number and updates the global serial number. The SNMS replicates the updated global serial number to the other CA servers in the replication domain. The CA server assigns a serial number to a certificate using a serial number from the new set of the unused serial numbers.

When an initial subsystem is cloned, the initial subsystem needs to be able to assign serial numbers immediately to a clone. To be able to do this, the initial subsystem can transfer a portion of its serial numbers from its current range of serial numbers to the cloned system. The SNMS 200 can also be used to issue and manage replication identifiers (IDs). When a subsystem is cloned, such as a CA server, the initial subsystem and each clone of the initial subsystem has a unique replication ID. The SNMS 200 can be used to ensure that each subsystem in a replication topology has a unique replication ID.

The high availability certificate system 100 can also include an initial Data Recovery Manager (DRM) server 123 and clones of the initial DRM server 125,127. A DRM server can be any type of computing device including server computers, desktop computers, laptop computers, hand-held computers, or similar computing device. Each DRM server 123-127 stores keys and certificates for recovering the keys if a token is lost or damaged. A DRM server 123-127 can include a SNMS 200 to issue and manage unique serial numbers for each key issued by a DRM server. CA servers 107-113 communicate with DRM servers 123-127 for recovering certificates. In one embodiment, CA servers 107-113 communicate with DRM servers 123-127 via a load balancer 121.

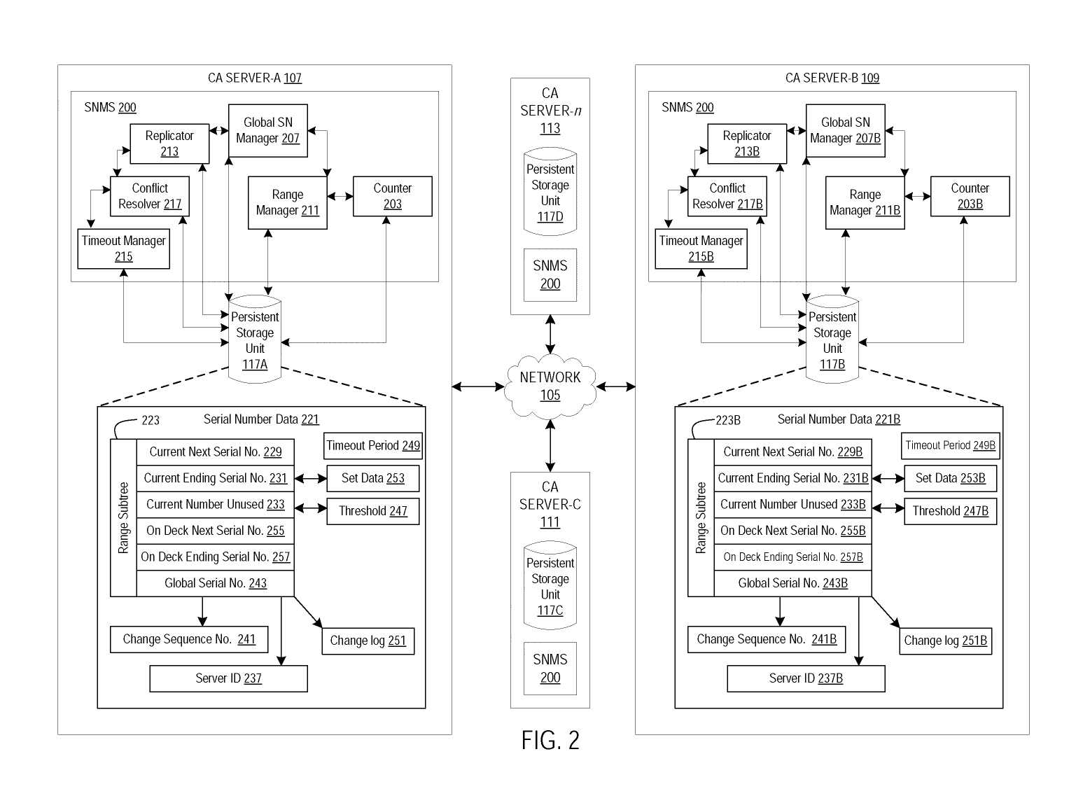

FIG. 2 is a block diagram illustrating an embodiment of a Serial Number Management System (SNMS) 200 for automatically managing the allocation of serial numbers to multiple certificate authority (CA) servers. Each CA server 107-113 includes a SNMS 200 and a persistent storage unit 117 (117A, B, C, D) to store data. The data in the persistent storage unit can be stored in an LDAP-based database. CA Server-A 107 is an initial CA server and CA Servers-B, C, n are clones of the initial CA server. Entries in each LDAP-based database 117A-D can be replicated to the other CA servers in a replication domain. A replication domain is a group of CA servers that replicate data to each other. For example, CA Servers-A, B, C, n are in the same replication domain.

A SNMS 200 includes a global serial number manager 207, a range manager 211, a replicator 213, a counter 203, a timeout manager 215, and a conflict resolver 217. This division of functionality is presented by way of example for sake of clarity. One skilled in the art would understand that the functionality described could be combined into a monolithic component or sub-divided into any combination of components.

A global serial number (SN) manager 207 manages a global serial number that is available to be used by any of the CA servers in the replication domain. All of the CA servers share a common configuration global serial number entry which defines an available serial number. The global serial number 243 is an entry in the LDAP-based database 117A that is replicated to other LDAP-based databases. The global SN manager 207 determines a value for the global serial number 243 and stores it as an entry in the range subtree 223. The global SN manager 207 can search the LDAP-based database 117A to obtain the global serial number 243. Each CA server in the replication domain, therefore, can determine the value of the global serial number 243. The global SN manager 207 can update the global serial number 243 by assigning a new value to the global serial number 243. The global SN manager 207 can add an entry to the LDAP-based database 117A to update the global serial number 243.

A range manager 211 keeps track of two sets (ranges) of serial numbers for a CA server, a set of serial numbers currently being used 229,231,233 and a set of serial numbers that is “on deck” 255,257 to be used next by the CA server once the current set of serial numbers is exhausted. Each CA server is assigned a unique range of serial numbers. The range manager 211 can store the current set of serial numbers that is assigned to the CA server and the on deck set of unused serial numbers in a range subtree 223. A current next serial number 229 is the serial number that a CA server can assign to the next certificate issued by the CA server. Each time a CA server uses a serial number to issue a certificate, the range manager 211 updates the current next serial number 229 accordingly. The current ending serial number 233 is the last serial number that a CA server currently is allowed to assign to a certificate issued by the CA server.

The current number unused 233 is the number of unused serial number that the CA server currently has available. A counter 203 determines the number of unused serial numbers for a CA server. As a CA server issues certificates, the counter 203 keeps track of the number of unused serial numbers for that particular CA server. The number of unused serial numbers for a CA server can be stored in a number unused 233 field in the range subtree 223 in an LDAP-based database 117A. The range manager 211 monitors the number of unused serial numbers 233 calculated by the counter 203 to detect that a CA server has a need for a new (on deck) set of unused serial numbers. The range manager 211 compares the number of unused serial numbers 233 to a threshold 247 to determine whether the CA server has reached a low-water mark threshold. The threshold 247 can be stored in an LDAP-based database 117A. The threshold 247 can be a user-defined value (e.g., 100).

When the current number of unused 233 serial numbers reaches a low-water mark threshold, the range manager 211 obtains the new (on deck) set of unused serial numbers 255,257 using the global serial number 243 that is stored in the LDAP-based database 117A. The range manager 211 defines the on deck set of unused serial numbers for the CA server using the on deck next serial number 255 and the on deck ending serial number 257. The range manager 211 can assign a value to the on deck next serial number 255 that is greater than or equal to the value of the global serial number 243. The range manager 211 can assign a value to the on deck ending serial number 257 that is based on the on deck next serial number 255. For example, the range manager 211 can assign a value to the on deck ending serial number 257 that is 500,000 greater than the on deck next serial number 255. The global serial number manger 207 updates the global serial number 243 to a value that is greater than the on deck ending serial number 257. The relationship between the on deck next serial number 255 and the on deck ending serial number 257 can be user-defined. Data defining the relationship between the on deck next serial number 255 and the on deck ending serial number 257 can be stored in the LDAP-based database 117A as set data 253.

A CA server exhausts its current set of serial numbers when the CA server issues a certificate using the current ending serial number 231. The CA server can then use the value of the on deck set of unused serial numbers as its current set of serial numbers. The range manager 211 changes the value of the current next serial number 229 to that of the on deck next serial number 255 and changes the value of the current ending serial number 231 to that of the on deck ending serial number 257. The range manger 211 can clear the value of the on deck next serial number 255 and the value of the on deck ending serial number 257.

For example, CA Server-A 107 has a current set of serial numbers from 0 to 1000 and CA Server-B 109 has a current set of serial numbers from 1001 to 2000. The global serial number 243,243B is 2001 and the threshold 247,247B is 300. CA Server-A 107 issues 700 certificates and the current number of unused 233 serial numbers for CA Server-A 107 is 300. CA Server-A 107 meets the low-water mark threshold and determines that the global serial number 243 is 2001. CA Server-A 107 obtains an on deck set of unused serial numbers based on the global serial number of 2001 and the set data 253 (e.g., 1000). For example, the on deck set of unused serial numbers is 2001 to 3001. CA Server-A 107 updates the global serial number to 3002. The global serial number is replicated to the other CA servers (e.g., CA Server-B 109). CA Server-A 107 assigns its on deck next serial number 255 to 2001 and its on deck ending serial number 257 to 3001. CA Server-A 107 continues to issue certificates using its remaining current set of unused serial numbers of 701 to 1000. When CA Server-A 107 issues a certificate using the current ending serial number of 1000, the CA Server-A 107 copies the next 255 and ending 257 serial numbers from the on deck range to the current range 229,231 and can clear the on deck values 255,257.

The range manager 211 also detects if a CA server is removed from a high availability certificate system. The range manager 211 can mark the unused serial numbers previously assigned to the removed CA server as available. The unused serial numbers previously assigned to the removed CA server can also simply be abandoned.

The replicator 213 replicates the global serial number 243 to all of the other CA servers in the replication domain. When a global serial number 243 entry is changed (e.g., the global serial number 243 is updated), the replicator 213 records a change sequence number 241 for the change and the server ID 237 of the CA server where the change was made. Each CA server is responsible for recording changes made to the LDAP-based database it manages. The changes can be maintained in a change log 251.

A conflict resolver 217 determines whether updating the global serial number is successful by determining whether a change made to the global serial number 243 causes a replication conflict. A replication conflict occurs when the global serial number in an LDAP-based database is modified by multiple servers at the same time. For example, two CA servers can increment the global serial number at the same time causing a replication conflict. The conflict resolver 217 can search the LDAP-based database 117A for a replication conflict entry that corresponds to the CA server and can delete any replication conflict entries that are found.

A timeout manager 215 determines whether a timeout period 249 has expired. A timeout period 249 defines a period of time for when a CA server periodically searches for a replication conflict. The timeout period 249 can be stored in the LDAP-based database 117A. The timeout period can be a user-defined time period (e.g., 10 seconds).

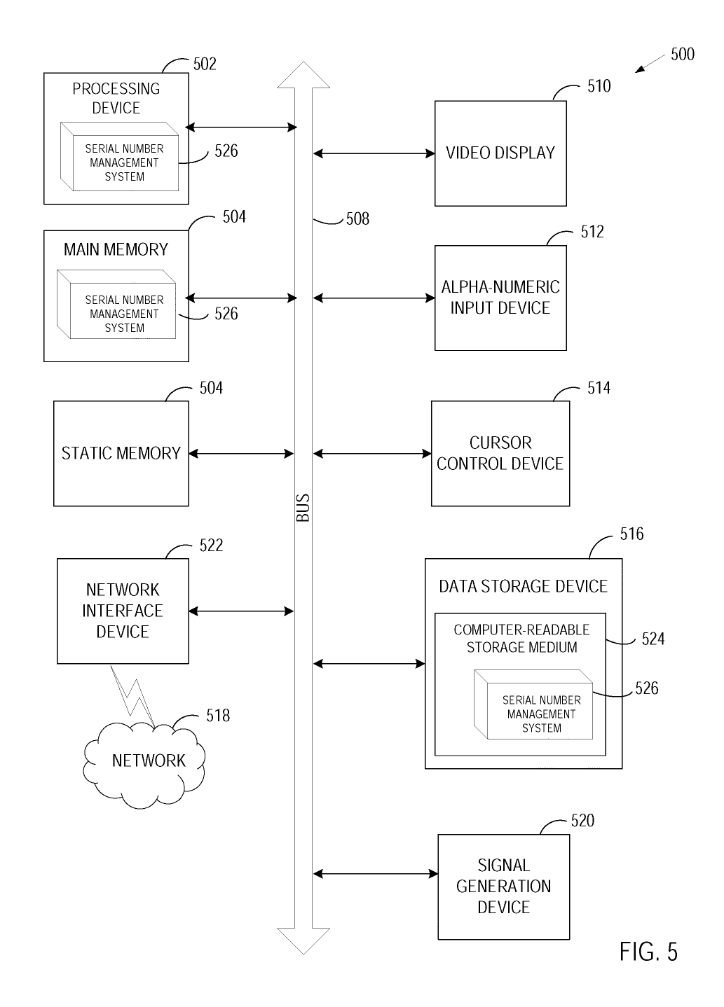

The global serial number manager 207, the range manager 211, the replicator 213, the counter 203, the timeout manager 215, and the conflict resolver 217 can be implemented as hardware, computer-implemented software, firmware or a combination thereof. In one embodiment, the global serial number manager 207, the range manager 211, the replicator 213, the counter 203, the timeout manager 215, and the conflict resolver 217 comprise instructions stored in memory 504 that cause a processing device 502 in FIG. 5 described in greater detail below to perform the functions of the global serial number manager 207, the range manager 211, the replicator 213, the counter 203, the timeout manager 215, and the conflict resolver 217.

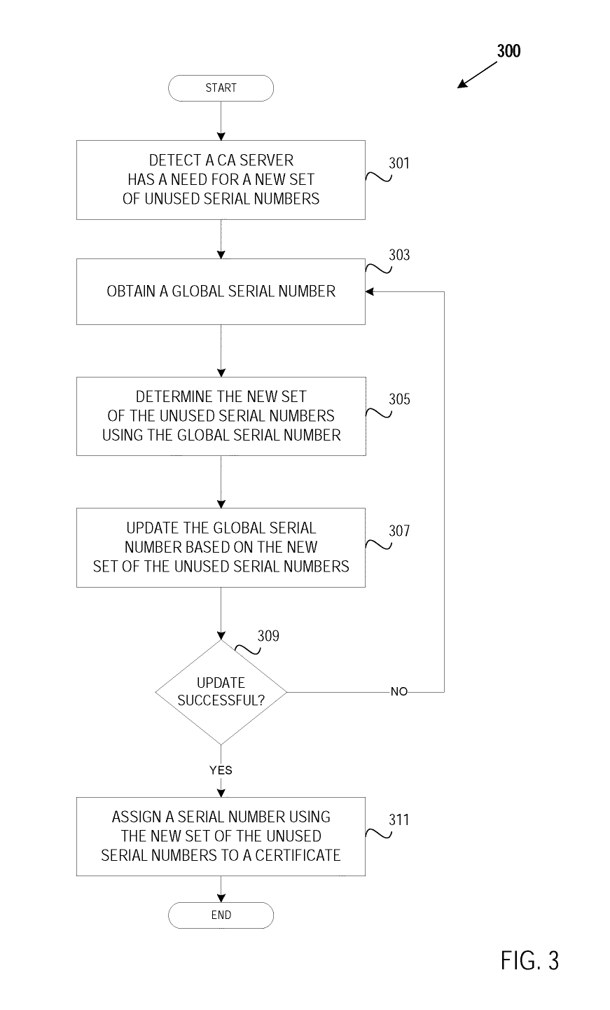

FIG. 3 is a flowchart which illustrates an embodiment of a method 300 for automatically detecting that a CA server has a need for a new set of unused serial numbers and obtaining the new set of unused serial numbers in an environment having multiple certificate authority servers. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by the SNMS 200 in a CA server 107-113 of FIGS. 1 and 2.

In one embodiment, this method can be initiated by a CA server automatically detecting (without user interaction) that it has a need for a new set of unused serial numbers at block 301. A CA server may have a need for unused serial numbers when the CA server is newly installed and does not have any serial numbers. A CA server may also have a need for unused serial numbers when the number of unused serial numbers of the CA server meets a low-water mark threshold.

At block 303, the CA server obtains a global serial number and identifies the value of the global serial number. The global serial number is a serial number that is available to be used by any of the CA servers in the replication domain. At block 305, the CA server determines the new (on deck) set of serial numbers using the global serial number. The CA server uses a value that is greater than or equal to the global serial number as it on deck next serial number. For its on deck ending serial number, the CA server can use a value based on a user defined relationship with the on deck next serial number. For example, the CA server can update its on deck ending serial number to 500,000 greater than the on deck next serial number. At block 307, the CA server updates the global serial number based on the new set of the unused serial numbers.

At block 309, the CA server determines whether updating the global serial number is successful. Updating the global serial number may not be successful if updating the global serial number causes a replication conflict. If updating the global serial number is successful (block 309), the CA server can assign a serial number using the new set of unused serial numbers to a certificate at block 311 and the method completes. If the updating the global serial number is not successful (block 309), the CA server returns to block 303 to obtain the global serial number and to identify the new value of the global serial number. The value of the global serial number may have changed since the last identification and the CA server identifies the new value of the global serial number when returning to block 303. The CA server continues to block 305 to determine another new set of unused serial numbers using the new global serial number.

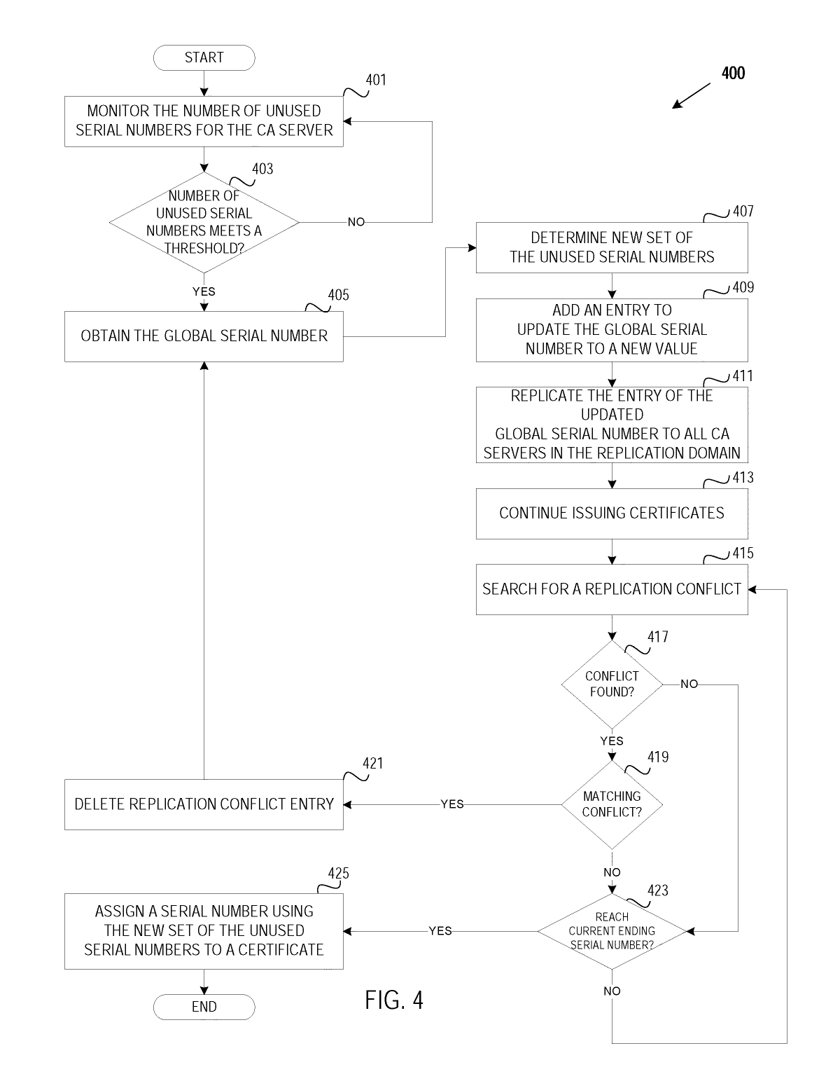

FIG. 4 is a flowchart which illustrates an embodiment of a method 400 for automatically requesting and obtaining additional serial numbers in an environment having multiple certificate authority servers. Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by the SNMS 200 on a CA server 107-113 of FIGS. 1 and 2.

In one embodiment, this method can be initiated by a CA server monitoring its number of unused serial numbers at block 401. Each CA server is assigned a unique set of unused serial numbers. The CA server can store its assigned set of unused serial number in a range subtree using a next serial number field and an ending serial number field. The next serial number value is the serial number that a CA server assigns to the next certificate issued by the CA server. The ending serial number value is the last serial number that a CA server can assign to a certificate issued by the CA server. For example, CA Server-A is assigned a current set of serial numbers from 500,000 to 750,000. The current next serial number value for CA Server-A is 500,000 and the current ending serial number value is 750,000.

At block 401, each time a CA server uses a serial number to issue a certificate, the CA server updates the current next serial number field accordingly. For example, when CA Server-A uses its first serial number to issue its first certificate, CA Server-A updates the current next serial number field value to 500,001, where 500,001 is the serial number of the next certificate to be issued by CA Server-A. A counter can keep track of the number of unused serial numbers of the CA server. For example, CA Server-A has issued 249,900 certificates, and thus, has used the serial numbers 500,000 to 749,900. A counter determines that the number of unused serial numbers for CA Server-A is 100.

At block 403, the CA server detects whether it has a need for a new (on deck) set of unused serial number by comparing its number of unused serial numbers meets a low-water mark threshold. The threshold can be stored in the LDAP-based database. If the CA server has not met the low-water mark threshold (block 403), the CA server returns to block 401 to continue to monitor its number of unused serial numbers. If the CA server determines that its number of unused serial numbers meets a low-water mark threshold (block 403), the CA server continues to block 405.

At block 405, the CA server obtains the global serial number. Each CA server in the replication domain maintains a global serial number entry in its corresponding LDAP-based database. The global serial number entry is replicated to all of the other CA servers in the replication domain. A CA server can search its LDAP-based database for the global serial number entry. For example, the CA server searches the LDAP-based database and determines that the global serial number is 750,001, which indicates that the serial number 750,001 is a serial number that is available to be used by any of the CA servers in the replication domain.

At block 407, the CA server determines the new (on deck) set of the unused serial numbers using the global serial number. The CA server defines a new set of unused serial numbers by assigning a value as its on deck next serial number that is greater than or equal to the value of the global serial number. For example, the value of the global serial number is 750,001 and the CA server assigns its on deck next serial number the value of 750,001 (or a value greater than 750,001). The CA server assigns a value to its on deck ending serial number that is based on the on deck next serial number (e.g., 500,000 greater than the next serial number). For example, where the on deck next serial number has a value of 750,001, the CA server assigns a value of 1,250,001 to the on deck ending serial number.

At block 409, the CA server updates the global serial number by adding a global serial number entry to the LDAP-based database. The global serial number entry is a serial number that is greater than the highest serial number in the new set of the unused serial numbers (the on deck ending serial number). For example, where the on deck ending serial number is 1,250,001, the CA server updates the global serial number from 750,001 to 1,250,002.

At block 411, the CA server replicates entry for the updated global serial number to the other CA servers in the replication domain. Using the example above, the updated value of 1,250,002 is recorded in a change log and replicated to the other CA servers. The replication of the global serial number entry amongst all of the CA servers enables all of the CA servers to identify that the serial number 1,250,002 is available to be used by any of the CA servers in the replication domain.

At block 413, the CA server continues to issue certificates using its remaining current set of unused serial numbers. For example, the CA server continues to issue certificates using its remaining current unused serial numbers of 749,901 to 750,000.

At block 415, the CA server periodically searches the LDAP-based database for replication conflict entries. The CA server can periodically checks for a replication conflict until it has reached its current ending serial number, which is described in greater detail in conjunction with block 423 below. The CA server can search periodically based on time, based on a number of certificates issued (e.g., every 10 seconds, every 5000 certificates). A replication conflict can occur when two CA servers update the global serial number at the same time. A replication conflict entry can be generated for the CA server that has the highest change sequence number. At block 417, if the CA server does not find a replication conflict entry, the CA server continues to block 423 to determine whether a timeout period has expired.

If the CA server does find a replication conflict entry (block 417), the CA sever determines whether the replication conflict entry has a server ID that matches the server ID of the CA server at block 419. For example, CA Server-A updates the global serial number to 1,250,002 and at the same time, the CA Server-B also updates the global serial number to 1,250,002. The change made by CA Server-B has a change sequence number that is higher than the change made by CA Server-A and a replication conflict entry for CA Server-B is generated. The replication conflict entry includes the server ID that corresponds to CA Server-B. Each of the CA servers (e.g., CA Server-A and CA Server-B) determines whether the server ID in the replication conflict entry matches its server ID.

If a matching replication conflict entry is found (block 419), the CA server determines that its attempt to update the global serial number was unsuccessful and deletes the replication conflict entry at block 421. The CA server returns to block 405 to obtain the global serial number and to identify the new value of the global serial number. The value of the global serial number may have changed since the last identification. If a matching replication entry is not found (block 419), the CA server continues to block 423.

At block 423, the CA server determines whether it has reached its current ending serial number. For example, the CA server issued a certificate using its current ending serial number of 750,000. If the CA server has not issued a certificate using its current ending serial number, the CA server returns to block 415 to continue searching for a replication conflict entry. If the CA server has issued a certificate using its current ending serial number (block 423), the CA server continues to block 425. At block 425, the CA server copies the on deck next serial number and the on deck ending serial number to the current next serial number and the current ending serial number. For example, the CA servers have a current next serial number and a current ending serial number of 750,001 to 1,250,001. The CA server can also clear the on deck values. The CA server can assign a serial number of 750,001 to a certificate and the method completes.

FIG. 5 is a diagram of one embodiment of a computer system for automatically managing the allocation of unique certificate serial numbers to certificate authority servers in a replicated server environment. Within the computer system 500 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or DRAM (RDRAM), etc.), a static memory 506 (e.g., flash memory, static random access memory (SRAM), etc.), and a secondary memory 516 (e.g., a data storage device in the form of a drive unit, which may include fixed or removable computer-readable storage medium), which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the serial number management system 526 for performing the operations and steps discussed herein.

The computer system 500 may further include a network interface device 522. The computer system 500 also may include a video display unit 510 (e.g., a liquid crystal display (LCD) or a cathode ray tube (CRT)) connected to the computer system through a graphics port and graphics chipset, an alphanumeric input device 512 (e.g., a keyboard), a cursor control device 514 (e.g., a mouse), and a signal generation device 520 (e.g., a speaker).

The secondary memory 516 may include a machine-readable storage medium (or more specifically a computer-readable storage medium) 524 on which is stored one or more sets of instructions (e.g., the serial number management system 526) embodying any one or more of the methodologies or functions described herein. The serial number management system 526 may also reside, completely or at least partially, within the main memory 504 and/or within the processing device 502 during execution thereof by the computer system 500, the main memory 504 and the processing device 502 also constituting machine-readable storage media. The serial number management system 526 may further be transmitted or received over a network 518 via the network interface device 522.

The computer-readable storage medium 524 may also be used to store the serial number management system 526 persistently. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The serial number management system 526, components and other features described herein (for example in relation to FIG. 2) can be implemented as discrete hardware components or integrated in the functionality of hardware components such as ASICS, FPGAs, DSPs or similar devices. In addition, the serial number management system 526 can be implemented as firmware or functional circuitry within hardware devices. Further, the serial number management system 526 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “detecting”, “determining,” “obtaining,” “replicating,” “adding,” “assigning,” “searching,” “maintaining,” “updating,” “accessing,” “identifying,” “deleting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for automatically managing the allocation of unique certificate serial numbers to certificate authority servers in a replicated server environment has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method, implemented by a Certificate Authority (CA) server computing system programmed to perform the following, comprising:
detecting, by the CA server computing system, that the CA server computing system has a need for a new set of unused serial numbers;
obtaining, by the CA server computing system, a global serial number that is available to be used by any of a plurality of CA servers in a replication domain;
determining, by the CA server computing system, the new set of the unused serial numbers using the global serial number; and
updating, by the CA server computing system, the global serial number based on the new set of the unused serial numbers.

2. The method of claim 1, further comprising:
replicating, by the CA server computing system, the updated global serial number to the other CA servers in the replication domain.

3. The method of claim 1, wherein determining the new set of the unused serial numbers comprises:
updating, by the CA server computing system, an on deck next serial number entry in a Lightweight Directory Access Protocol (LDAP)-based database that corresponds to the CA server computing system to match the global serial number, wherein the on deck next serial number is a serial number to be assigned by the CA server computing system to a certificate that is to be issued next by the CA server computing system when the CA server computing system exhausts a current set of serial numbers; and
updating, by the CA server computing system, an on deck ending serial number entry in the LDAP-based database, wherein the on deck ending serial number entry is a last serial number to be assigned by the CA server computing system to a certificate to be issued by the CA server computing system.

4. The method of claim 1, wherein updating the global serial number comprises:
adding, by the CA server computing system, an entry to an LDAP-based database that assigns a value to the global serial number that is greater than the highest serial number in the new set of the unused serial numbers.

5. The method of claim 1, further comprising:
determining, by the CA server computing system, whether updating the global serial number causes a replication conflict; and
assigning, by the CA server computing system, a serial number to a certificate using a serial number from the new set of the unused serial numbers in response to a determination that updating the global serial number did not cause a replication conflict.

6. The method of claim 5, further comprising:
deleting, by the CA server computing system, a replication conflict entry in an LDAP-based database in response to a determination that updating the global serial number causes a replication conflict;
obtaining, by the CA server computing system, a new global serial number;
determining, by the CA server computing system, another new set of unused serial numbers using the new global serial number;
updating, by the CA server computing system, the new global serial number; and
replicating, by the CA server computing system, the updated new global serial number to the other CA servers in the replication domain.

7. The method of claim 5, determining whether updating the global serial number causes a replication conflict comprises:
searching, by the CA server computing system, an LDAP-based database that corresponds to the CA server computing system for a replication conflict entry; and
determining, by the CA server computing system, that updating the global serial number caused a replication conflict by locating a replication conflict entry that includes a server ID that matches a server ID of the CA server computing system.

8. The method of claim 1, wherein obtaining a global serial number comprises:
maintaining, by the CA computing system, an LDAP-based database and storing a global serial number entry in the LDAP-based database, wherein the global serial number entry is replicated to other LDAP-based databases when the global serial number entry is updated; and
identifying, by the CA server computing system, a value of the global serial number entry stored in the LDAP-based database.

9. The method of claim 1, wherein detecting a need for a new set of unused serial numbers comprises:
determining, by the CA server computing system, a number of unused serial numbers that corresponds to the CA server computing system meets a low-water mark threshold.

10. A system comprising:
a Certificate Authority (CA) server in a replication domain to receive and process certificate requests from a client computer over a network;
a persistent storage unit coupled to the CA server to store a global serial number that is available to be used by any of the plurality of CA servers; and
a serial number management system on the CA server to detect that the CA server has a need for a new set of unused serial numbers; to obtain the global serial number, to determine the new set of the unused serial numbers using the global serial number, to update the global serial number based on the new set of the unused serial numbers, and to replicate the updated global serial number to other CA servers in the replication domain.

11. A computer-readable storage medium including instructions that, when executed by a computer system, cause the computer system to perform a set of operations comprising:
detecting that the CA server computing system has a need for a new set of unused serial numbers;
obtaining a global serial number that is available to be used by any of a plurality of CA servers in a replication domain;
determining the new set of the unused serial numbers using the global serial number; and
updating the global serial number based on the new set of the unused serial numbers.

12. The computer-readable storage medium of claim 11, further comprising:
replicating the updated global serial number to the other CA servers in the replication domain.

13. The computer-readable storage medium of claim 11, wherein determining the new set of the unused serial numbers comprises:
updating an on deck next serial number entry in a LDAP-based database that corresponds to the CA server computing system to match the global serial number, wherein the on deck next serial number is a serial number to be assigned by the CA server computing system to a certificate that is to be issued next by the CA server computing system when the CA server computing system exhausts a current set of serial numbers; and
updating an ending serial number entry in the LDAP-based database, wherein the ending serial number entry is a last serial number to be assigned by the CA server computing system to a certificate to be issued by the CA server computing system.

14. The computer-readable storage medium of claim 11, wherein updating the global serial number comprises:
adding an entry to an LDAP-based database that assigns a value to the global serial number that is greater than the highest serial number in the new set of the unused serial numbers.

15. The computer-readable storage medium of claim 11, further comprising:
determining whether updating the global serial number causes a replication conflict; and
assigning a serial number to a certificate using a serial number using the new set of the unused serial numbers in response to a determination that updating the global serial number did not cause a replication conflict.

16. The computer-readable storage medium of claim 15, further comprising:
deleting a replication conflict entry in an LDAP-based database in response to a determination that updating the global serial number causes a replication conflict;
obtaining a new global serial number;
determining another new set of unused serial numbers using the new global serial number;
updating the new global serial number; and
replicating the updated new global serial number to the other CA servers in the replication domain.

17. The computer-readable storage medium of claim 15, determining whether updating the global serial number causes a replication conflict comprises:
searching an LDAP-based database that corresponds to the CA server computing system for a replication conflict entry; and
determining that updating the global serial number caused a replication conflict by locating a replication conflict entry that includes a server ID that matches a server ID of the CA server computing system.

18. The computer-readable storage medium of claim 11, wherein obtaining a global serial number comprises:
maintaining an LDAP-based database and storing a global serial number entry in the LDAP-based database, wherein the global serial number entry is replicated to other LDAP-based databases when the global serial number entry is updated; and
identifying a value of the global serial number entry stored in the LDAP-based database.

19. The computer-readable storage medium of claim 11, wherein detecting a need for a new set of unused serial numbers comprises:
determining a number of unused serial numbers that corresponds to the CA server computing system meets a low-water mark threshold.

20. A Certificate Authority (CA) server comprising:
memory to store a global serial number that is replicated to a plurality of CA servers in a replication domain and is available to be used as a serial number by any of the plurality of CA servers in the replication domain;
a global serial number manager coupled to the memory to obtain the global serial number and to update the global serial number; and
a range manager coupled to the global serial number manager to detect that the CA server has a need for a new set of unused serial numbers and to determine the new set of the unused serial numbers using the global serial number.
